(19) United States
(12) Patent Application Publication
(10) Pub. No.: US 2010/0270905 A1
(43) Pub. Date: Oct. 28, 2010

(54) LED LAMP

(76) Inventor: Sam Pyo Hong, Seoul (KR)

Correspondence Address: JHK LAW, P.O. BOX 1078, LA CANADA, CA, 91012-1078, US

(21) Appl. No.: 12/810,799

(22) PCT Filed: Dec. 29, 2008
(86) PCT No.: PCT/KR08/07756

§ 371 Date: Jun. 25, 2010

(30) Foreign Application Priority Data
Dec. 27, 2007 (KR) 10-2007-0139041

(51) Int. Cl. H01J 61/52

(52) U.S. Cl. 313/46

(57) ABSTRACT

A light emitting diode (LED) lamp is provided to efficiently emit generated heat and increase light intensity radiating toward the front portion, and also to enhance productivity, save cost, and provide more elegant appearance. The LED lamp includes a front cover, a body, and a socket, in which the front cover includes a lens hole and a bolt securing portion without a front ventilation opening and a fixation bolt, the body includes a bolt securing hole, a side ventilation opening, a heat dissipation groove, a socket engagement hole, a heat conductive substrate, a lens, and a cable path, and the socket includes a driving substrate, an electrode hole, a guide and a hooking portion without adhesives in the interior portion.

### TECHNICAL FIELD

The present invention relates to a light emitting diode (LED) lamp, and more particularly, to a LED lamp capable of solving the decline problems of heat dissipation and light radiation intensity, and enhancing output, saving cost, and providing more elegant appearance.

### BACKGROUND ART

Conventional MR16-type LED lamps have advantages in less power consumption, lower surface temperature, and longer lifetime than halogen lamps do. However, the LED lamps also have drawbacks, that is, higher price and less light emission brightness than halogen lamps.

Many attempts have been made to solve the above problems. The most critical point is to manufacture a LED lamp emitting lower heats on the surface without affecting brightness because the LED lamp lifetime itself decreases as more heat is generated. For instance, installing a ventilation fan in the interior lamp or using the ceramic body to encourage the heat emission rate has been suggested; both have problems in high cost and low productivity.

Further, a MR 16-type LED lamp is so small that it may not provide enough space for a control board. Thus, if the product design fails to address the above difficulty, productivity drops and the cost increases.

### DISCLOSURE OF INVENTION

### Technical Problem

The present invention is suggested to solve the abovementioned problems of the prior art, and accordingly, it is an object of the present invention to provide a light emitting diode (LED) lamp capable of not only efficiently emitting generated heats and increasing light intensity radiated toward the front, but also enhancing productivity, saving cost, and providing a more elegant design.

### Technical Solution

The present invention is provided to resolve the problems occurring in the prior art, and therefore, it is an object of the present invention to provide a light emitting diode (LED) lamp including a front cover; a body; and a socket, wherein the front cover comprises a lens hole accepting a lens therein to vertically collect light radiated from a LED, and a bolt securing portion formed in the back of the front cover; the body comprises a bolt securing hole capable of being coupled to the bolt securing portion, a plurality of side ventilation openings formed only on the upper round of the body, and preventing light of the LED from emitting to the side of the body while emitting the heat from the LED, a socket engagement hole enabling removable engagement of the socket, a conductive substrate provided with the LED on the surface and arranged in the lower interior of the body, a lens for vertically collecting light emitted from the LED, and a cable path for passing a cable connected to the LED to the socket; and the socket comprises a driving substrate connected to the cable from the LED and solder-connected to the electrode pin, an electrode hole for passing the electrode pin to the outside, a guide for enabling removable engagement of the driving substrate, and a hooking portion capable of being coupled to a socket engagement hole of the body.

The front cover may exclude a front ventilation opening and a fixation bolt on a front portion.

The section of the electrode pin coupled to the electrode hole of the socket may be circle, rectangle, or hexagon as the same as that of the electrode hole, whereby the electrode hole and the electrode pin are closely engaged with each other.

The body is usable for both 3×LED lamp and 1×LED lamp.

The electrode pin connected to the driving substrate may be L-shape or straight.

The body may be comprised of a heat conductive metal.

The body may further include a heat dissipation groove connected to the side ventilation opening, and extended from upper to lower portion of an outer surface of the body, to efficiently dissipate heat generated from the LED.

The heat dissipation groove formed on the outer surface of the body may be formed clockwise or counterclockwise.

The section of the side ventilation opening may be rectangle, circle, or oval.

The socket may exclude an adhesive in an interior portion.

### ADVANTAGEOUS EFFECTS

The LED lamp according to an embodiment of the present invention efficiently emits generated heats and increases intensity of light radiating toward the front portion. The lamp also has effects in enhancing productivity, saving costs, and providing elegant appearance.

The effects of the LED lamp according to the embodiments of the present invention are further explained below.

First, the front cover includes only lens hole on the surface without the ventilation opening and the fixation bolt, and thus has simple and clean design.

Second, the risk of performance deterioration caused due to ingress and accumulation of impure particles such as dust from the front is prevented, since the front cover is integrated with the lens and thus does not form a front ventilation opening.

Third, intensity of the vertical direction light is increased as loss of side horizontal-direction light radiated from the power LED is reduced, by forming a side ventilation opening in an oblique form instead of cube form, while interior is in cube form.

Fourth, as compared to conventional methods in which separate means such as adhesive is used to impregnate and fix the electrode pin and waiting time is required until the adhesive hardens, the electrode pin is mounted and soldered to the driving substrate, and the driving substrate is simply inserted into the guide installed in the interior of the socket. Accordingly, cost saving effect and simpler working process is provided.

Fifth, as compared to conventional methods in which several fixation bolts are used to engage the socket and the body, the socket is simply inserted into the body for engagement. Therefore, manufacturing time is decreased and productivity is subsequently enhanced.

Sixth, more elegant appearance is provided by using the bolt securing portion formed in the interior of the cover to fix the body while conventional methods mount the fixation bolt to the cover for engagement of the cover and body.

Seventh, working process is simplified and productivity is improved by reducing undesired escape or movement of the parts, since the electrode pin is formed in L-shape and soldered to the driving substrate, and coupled to the electrode hole by being inserted in the inside of the socket.

Eighth, productivity is improved and cost is decreased by greatly reducing working effort and assembly time.

Ninth, workload is reduced and cost is decreased because the body structure is compatible to various types of products.

Tenth, air contact area is increased and thus heat dissipation area is increased since the heat dissipation vanes are formed clockwise or counterclockwise on the outside of the body, and the side ventilation opening looks relatively smaller than its actual size when viewed from the exterior of the body since the ventilation opening is formed in oblique shape to the exterior of the body while the ventilation opening is in rectangular form in the inside of the body.

### BRIEF DESCRIPTION OF THE DRAWINGS

FIG. 1A is a side cross-sectional view of a light emitting diode (LED) lamp according to an embodiment of the present invention, and FIG. 1B is a side cross-sectional view of a LED lamp according to another embodiment of the present invention.

FIGS. 2A to 2D are side cross-sectional views of the LED lamps according to yet another embodiment of the present invention.

FIG. 3A shows a socket according to an embodiment of the present invention, and FIG. 3B shows a socket according to another embodiment of the present invention.

FIG. 4 is a view of the lens constitution according to an embodiment of the present invention.

FIG. 5A shows a front cover according to an embodiment of the present invention, and FIG. 5B shows a front cover according to another embodiment of the present invention.

FIG. 6 shows the electrode pin constitution according to an embodiment of the present invention.

FIG. 7 shows the body constitution according to an embodiment of the present invention.

FIG. 8 is a view provided to explain maximization of heat dissipation effects and minimization of front light emission decline by the body.

### BEST MODE FOR CARRYING OUT THE INVENTION

The preferred embodiments of the present invention are further explained below with reference to the accompanying drawings.

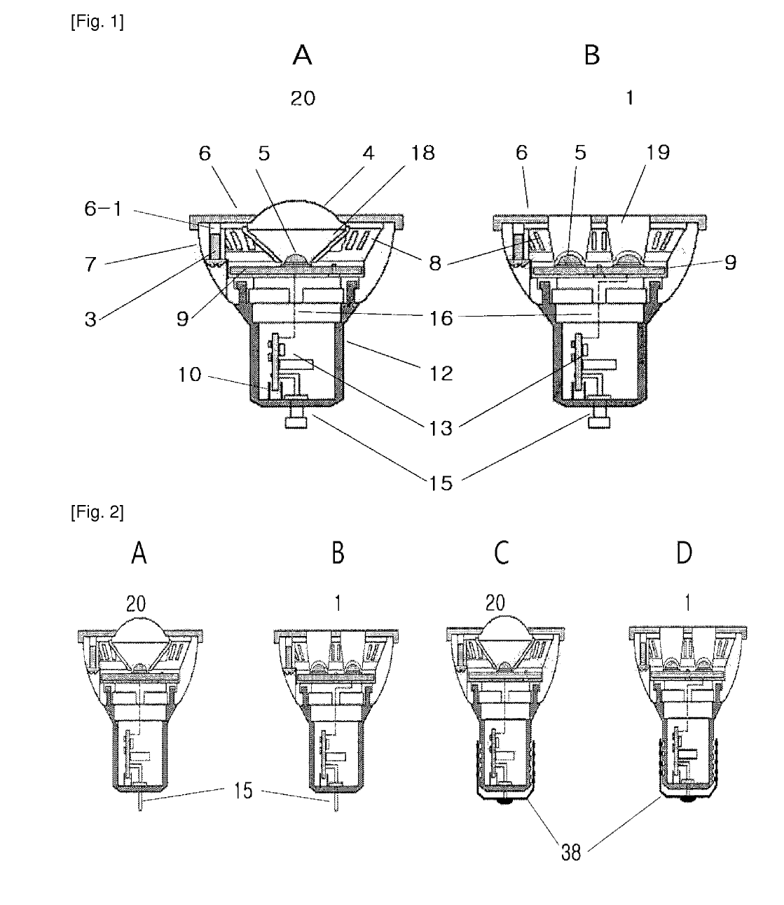

FIG. 1A is a side cross-sectional view of a LED lamp according to an embodiment of the present invention, and FIG. 1B is a side cross-sectional view of a LED lamp according to another embodiment of the present invention.

FIG. 1A shows a 1×MR16 LED lamp 20, while FIG. 1B shows a 3×MR16 LED lamp 1. FIGS. 1A and 1B are different from each other in that FIG. 1A uses a 1×LED lamp provided with a lens 4 and a lens support 18, while FIG. 1B uses a 3×LED lamp provided with a 3×lens 19.

According to FIG. 1, the LED lamp comprises a front cover 6, a body 7, and a socket 12.

The front cover 6 includes a lens hole (not drawn herein) accepting therein a lens to vertically collect light radiated from the LED; and a bolt securing portion 6-1 arranged in the back of the front cover, but excludes a front ventilation opening and a fixation bolt on the front face of the front cover 6. Accordingly, the front portion which users can see has elegant looks, and malfunction and fire caused by ingress and accumulation of impure material such as dust are prevented. Effective heat dissipation is also done by the body even without a front ventilation opening, as explained below.

The body 7 includes a bolt securing hole (not drawn herein) which can be bolt-coupled to the bolt securing portion 6-1; a plurality of side ventilation openings 8 only formed on the upper round of the body 7, and emitting heats generated from the LED 5 while preventing light radiated from the LED 5 from releasing toward side of the body; a heat dissipation groove (not drawn herein) coupled to the side ventilation opening 8 and formed from the upper exterior body to the lower, and efficiently dissipating heats generated from the LED 5; a socket engagement hole (not drawn herein) enabling removable engagement of the socket 12; a conductive substrate 9 provided with a LED 5 on the surface and arranged in the lower interior of the body; lenses 4, 19 for vertically collecting light radiated from the LED 5; and a cable path (not drawn herein) for passing the cable 16 connected to the LED 5 toward the socket.

The body 7 may be made of a heat conductive metal.

Further, the heat ventilation groove formed on the outer surface of the body 7 may be formed clockwise or counterclockwise.

The section of the side ventilation opening 8 may be rectangle, circle, or oval.

According to the present invention, the body has the side ventilation opening only formed on the upper portion, thereby guaranteeing more than a certain level of the light intensity because most light radiated from the LED emits toward the front without scattering and disappearing to the side. Meanwhile, decline of the heat dissipation effects due to the smaller ventilation opening is complemented by the heat dissipation groove extended from the upper exterior body to the lower, which guarantees effective heat dissipating function.

The socket 12 includes a driving substrate 13 connected to a cable 16 from the LED 5 and soldered to an electrode pin 15; an electrode hole (not drawn herein) for passing the electrode pin 15 to the outside; a guide 10 for removable engagement of the driving substrate 13; and a hooking portion capable of being coupled to the socket engagement hole of the body.

The section of the electrode pin 15 is circle, rectangle, or hexagon, as same as that of the electrode hole, to enable the electrode pin and the electrode hole to be closely coupled to each other. The electrode pin coupled to the driving substrate is L-shape or straight.

According to the present invention, since the socket uses the guide instead of adhesives to fix the driving substrate, the socket has simple manufacturing and repairing processes and subsequently increased productivity.

FIGS. 2A to 2D are side cross-sectional views of the LED lamps according to another embodiment of the present invention.

FIG. 2A shows a 1×MR16 LED lamp 20, FIG. 2B shows a 3×MR16 LED lamp 1, FIG. 2C shows a 1×LED lamp provided with the socket structure using an E26 base electrode pole, and FIG. 2D shows a 3×LED lamp using an E26 base electrode pole.

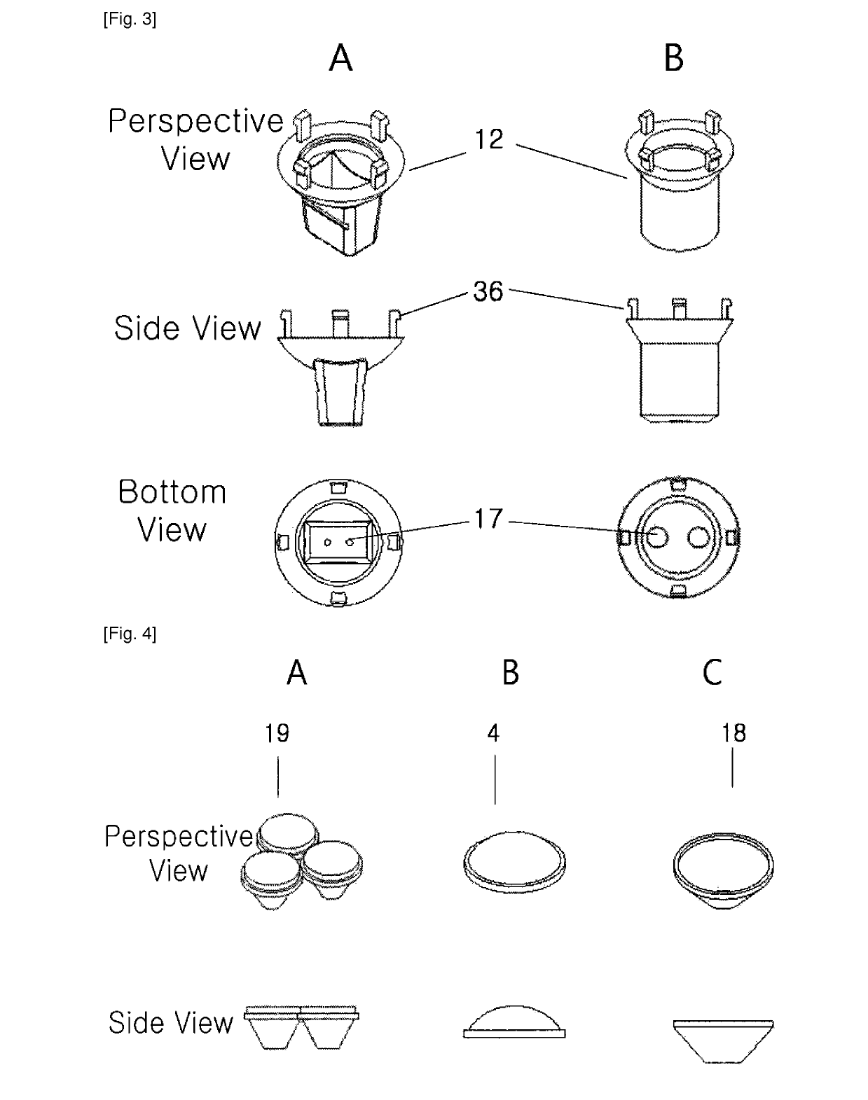

FIG. 3A shows a socket according to an embodiment of the present invention, and FIG. 3B shows a socket according to another embodiment of the present invention.

Referring to FIG. 3, the socket 12 includes a hooking portion 36 formed on an upper portion for removable engagement with the body 7, and an electrode hole 17 formed on a bottom portion for engagement of the electrode pin 15. The socket 12 also includes a separate guide 10 formed therein to facilitate fixation of the driving substrate 13 in place.

FIG. 4 is a view of the lens structure according to an embodiment of the present invention.

FIG. 4A shows a 3×lens 19, FIG. 4B shows a 1×lens 4, and FIG. 4C shows a lens support 18 of the 1×lens 4.

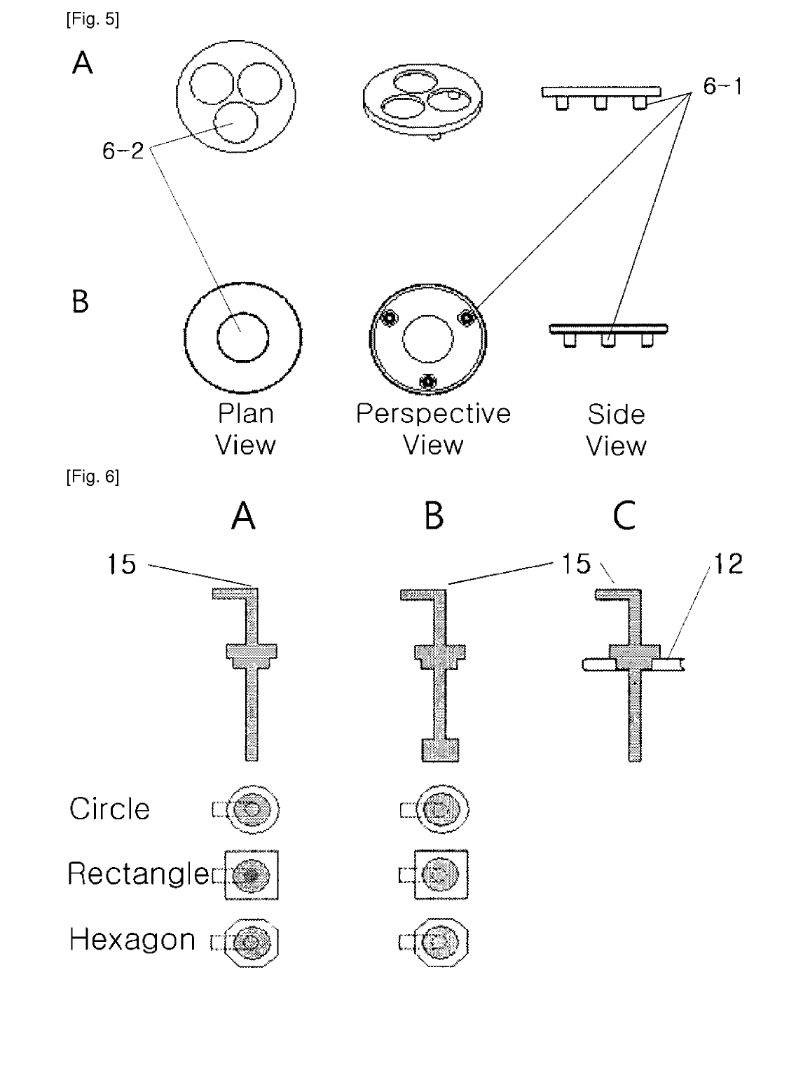

FIG. 5A shows a front cover according to an embodiment of the present invention, FIG. 5B shows a front cover according to another embodiment of the present invention.

Referring to FIG. 5, the front cover 6 comprises a bolt securing portion 6-1 for coupling to the body 7, formed in the back of the front cover 6, and a lens hole 6-2 for coupling to the lens 4. However, the front cover excludes a fixation bolt or a front ventilation opening on its front portion.

FIG. 6 shows the electrode pin structure according to an embodiment of the present invention.

Referring to FIG. 6, an electrode pin 15 is prepared by machining and bending a metal, and is connected to the electrode hole 17 in the lower portion of the socket 12. The electrode pin 15 is machined and bent as in FIG. 6 to firmly fix the electrode pin 15 and the socket 12, since it is relatively a hard work for a worker to mount the pin to the lamp socket. FIG. 6A shows embodiments in which the body is circle, rectangle, or hexagon in an example where a normal electrode is applied, and FIG. 6B shows embodiments in which the body is circle, rectangle, or hexagon in an example where a circle electrode is applied. FIG. 6C is a cross-sectional view showing engagement with the socket 12.

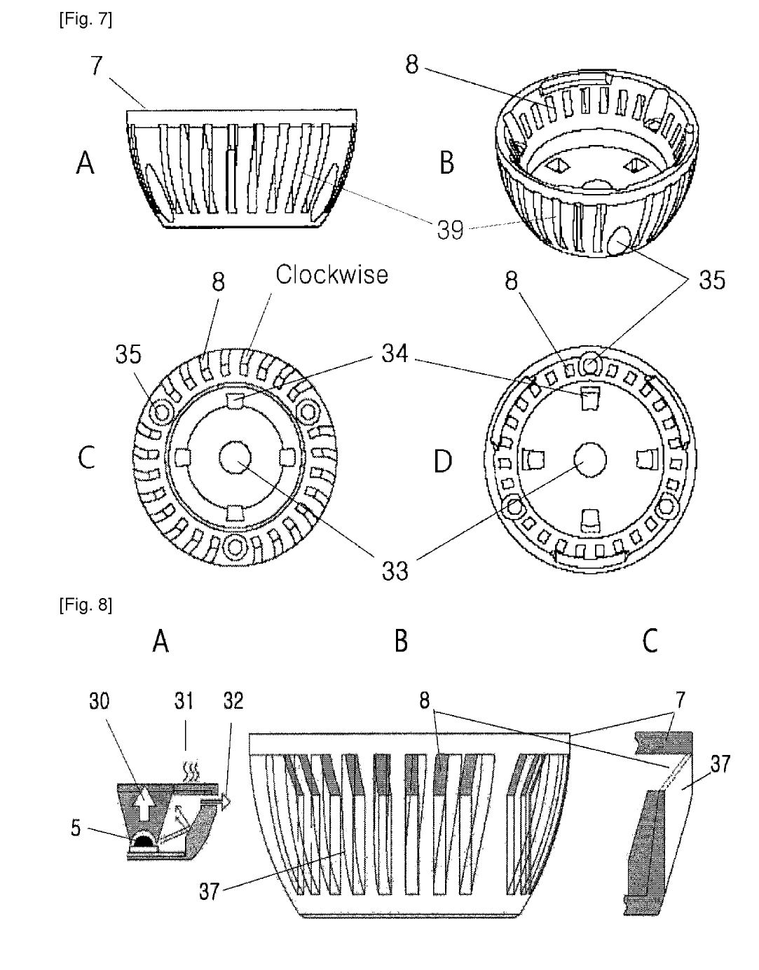

FIG. 7 shows the body constitution according to an embodiment of the present invention, and FIG. 8 is a view provided to explain maximization of heat dissipation effects and minimization of decrease in the front light emission intensity by the body according to an embodiment of the present invention.

Referring to FIG. 7, the body 7 comprises a side ventilation opening 8 formed on the side to dissipate inside high temperature heat. The body 7 also comprises a bolt securing hole 35 corresponding to the fixation bolt 3 to enable engagement of the body 7 with the front cover 6. The side ventilation opening 8 of the body 7 is particularly machined in an oblique form as shown in FIG. 8C to prevent loss of light radiated from the power LED 5 into the horizontal side direction. FIG. 8C is an enlarged view of the side ventilation opening 8.

Further, the body 7 comprises a socket engagement hole 34 as shown in FIG. 7 to enable engagement with the socket 12, and the socket 12 comprises a hooking portion 36 formed on one side as shown in FIG. 3. Thus, it is easy to engage the socket 12 with the body 7 at one time.

The power LED 5 is soldered to the conductive substrate 9, and the cable 16 for driving the power LED 5 is passed to the socket 12 through the cable path 33 of the body 7 as shown in FIG. 7.

The constitution and related effects of the present invention are further explained below.

First, a normal LED lamp comprises the side ventilation opening and the fixation bolt on its front cover, and thus fails to have clean and simple appearance. However, since LED lamps are usually used for interior design, inelegance may affect product value and limit application range.

Meanwhile, the LED lamp according to the embodiments of the present invention has clean and simple appearance because the front cover 6 only comprises the lens hole 6-2 for the 1×lens 4 or the 3×lens 19.

Second, the front of a normal LED lamp is projected when installed. Through the front ventilation opening, which is generally machined and formed in circle or angle form, impure material such as dust can enter and accumulated, causing the product performance depreciation or fire due to high temperature heat.

Meanwhile, since the LED lamp according to an embodiment of the present invention has an integrated form of the front cover 6 and the lens 4, ingress of impurities such as dust into the front is further prevented, and the risk of the product performance depreciation or fire by high temperature heat is reduced.

Third, in case of a normal LED lamp, the light radiated from the power LED passes out in both horizontal and vertical directions since the side ventilation opening in cube configuration is formed over the entire side of the body. However, light radiation only in the vertical direction is most desirable. If light radiates in the horizontal direction through the side ventilation opening, the intensity of the vertical-direction light is decreased, and thus the lamp brightness is also declined.

Meanwhile, the LED lamp according to an embodiment of the present invention has the side ventilation opening 8 of the body 7 only on the upper side, while the heat dissipation groove and vane connected to the side ventilation opening 8 are arranged on the exterior surface. Thus, loss of the side horizontal light 32 radiated from the power LED 5 is reduced as shown in FIG. 8A, so that the vertical direction light 30 is increased.

Fourth, the driving substrate mounted in the interior of the socket according to a normal LED lamp is so small that the driving substrate is impregnated by using adhesives without using another fixation method. This makes working process and repairing complicate, and productivity decreased.

Meanwhile, with the LED lamp according to an embodiment of the present invention, the electrode pin 15 is mounted and soldered to the driving substrate 13, which is inserted into the guide 10 in the interior of the socket 12. Since the worker is no longer required to impregnate and fix the electrode pin 15 using separate means such as adhesive and wait for the adhesive to harden, cost for production is reduced and working process is improved.

Fifth, since a normal LED lamp needs a separate fixation bolt to fix the socket, working process becomes complicated, productivity is decreased, and cost is increased.

Meanwhile, with the LED lamp according to an embodiment of the present invention, the body 7 comprises the socket engagement hole 34 to engage the socket 12 with the body 7 as shown in FIG. 7, and the socket 12 comprises the hooking portion 36 as shown in FIG. 3. Thus, it is easier to engage the socket 12 with the body 7, since a worker simply places the socket 12 near to the body 7 and inserts it, instead of using several fixation bolts as in the conventional LED lamps, and as a result, working time is decreased and productivity is increased.

Sixth, a normal LED lamp has problems of inelegant design of the front, increased cost and complicated working process, since it needs separate fixation bolts to fix the front cover.

Meanwhile, the LED lamp according to an embodiment of the present invention uses the bolt securing portion 6-1 formed inside of the cover 6 to engage the body 7 with the cover 6 and therefore, it is not necessary to mount the fixation bolt 3 to the cover 6. As a result, elegant appearance is provided.

Seventh, in case of a normal 3×MR16 LED lamp, it is necessary to solder-connect a cable of the electrode pin to the driving substrate in the interior of the socket, causing complicated working process, and thus decreased productivity. Likewise, a conventional 1×MR16 LED lamp also complicates working process and decreases productivity, since it is necessary to insert the electrode pin from the exterior of the socket to the interior, by compressing and fixing the pin to the interior of the socket, and by solder-connecting a separate cable therein to the driving substrate.

Meanwhile, with the LED lamp according to an embodiment of the present invention, the electrode hole 17 is engaged with the electrode pin 15 as shown in FIG. 6C by forming the electrode pin 15 in L-shape, soldering the pin 15 to the driving substrate 13, and inserting the pin 15 into the inside of the socket 12, thereby reducing undesirable escape or movement of the parts, facilitating working process and increasing productivity.

Eighth, a normal LED lamp is fabricated by the complicated and cumbersome processes of: inserting the electrode pin in the exterior through a hole of the lower portion of the socket; solder-connecting the pin in the interior to the cable; solder-connecting the pin to the driving substrate; inserting the driving substrate into the socket; and injecting fixation adhesives and waiting until the driving substrate is fixed after some time when the adhesives becomes solid. After the driving substrate becomes fixed, the working process continues by: passing the cable on the other side of the driving substrate through the hole of the lower portion of the body; and engaging the body and the socket with a separate fixation bolt. Finally, the fabricating process finishes by: connecting the power LED on one side of the conductive substrate inside of the body to the cable from the socket, thereby completing circuits; mounting the conductive substrate to the lower portion of the body; placing the 1×lens or the 3×lens on the upper portion of the power LED; and placing the cover on the lens in position and fixing it with a fixation bolt.

Meanwhile, the LED lamp according to an embodiment of the present invention is assembled by: mounting and soldering the electrode pin 15 on the driving substrate 13; inserting the foregoing into the guide 10 in the interior of the socket 12; passing the cable 16 from the driving substrate 13 through cable path 33 in the inside of the body 7; pushing and engaging the socket 12 to the body 7 without spending time in impregnating; connecting the cable from the body 7 to the electrode of the power LED 5 of the conductive substrate 9; placing the 3×lens 19 on the power LED 5 or, after the lens support 18 is placed on the power LED 5, placing the 1×lens 4 thereon. The assembling process is finished by placing the cover 6 in position and fastening a separate fixation bolt 3 at the bolt securing hole 35 of the body 7. Thus, the process results in saving work effort and assembly time to increase productivity and save cost.

Ninth, a normal LED lamp has a certain level of inner heat dissipation by comprising a front ventilation opening and a side ventilation opening. However, the body 7 cannot be shared by the 3×MR16 LED lamp 1 and the 1×MR16 LED lamp 20. Thus, because the body has different structure according to the type of LED lamp, production cost is increased.

Meanwhile, since the body 7 of the LED lamp according to an embodiment of the present invention may be shared by several types of lamps as shown in FIGS. 1 to 2, the advantageous effects such as reduced work load and cost are provided.

Tenth, a normal 3×MR16 LED lamp and a 1×MR16 LED lamp have to be driven with much electric current to augment brightness, and thus require the front ventilation opening and the side ventilation opening to dissipate high temperature heat generated due to the use of electric current. Thus, the normal lamp has a problem in the increase of size of the ventilation openings to dissipate the heat, which results in increase of the loss of the light radiation to the horizontal direction and subsequent declining of total brightness. The horizontal direction light loss may be avoided by reducing the size of the side ventilation opening to dissipate the heat, but in this case, the heat from the body is increased to reduce the lifetime of the power LED 5.

Meanwhile, the LED lamp according to an embodiment of the present invention may include the heat dissipation grooves 39 and the heat dissipation vanes 37 formed on the exterior of the body 7 clockwise or counterclockwise as shown in FIG. 7 to maximize air contacts, heat dissipation of the body 7, and decrease the temperature. Furthermore, the side ventilation opening 8 looks smaller when it is seen from the outside of the body 7. In addition, less horizontal direction light 32 is radiated from the interior of the body 7 as shown in FIG. 8A and as a result, the amount of vertical direction light 30 is increased.

Although the foregoing explanations are based on the embodiments shown in the drawings, these are examples of the present invention. One of ordinary skill in the art obviously understands other equivalent applications and embodiments according to the present invention. Therefore, the scope of protection for the present invention should be determined by the scope of claims.

1. A light emitting diode (LED) lamp comprising:
a front cover;
a body; and
a socket, wherein
the front cover comprises,
a lens hole for accepting a lens therein for vertically collecting light radiated from a LED, and
a bolt securing portion formed in the back of the front cover, the body comprises,
a bolt securing hole capable of being coupled to the bolt securing portion,
a plurality of side ventilation openings formed only on the upper round of the body, and preventing light of the LED from emitting to the side of the body while emitting the heat from the LED,
a socket engagement hole for removable engagement of the socket,
a conductive substrate provided with the LED on the surface and arranged in the lower interior of the body,
a lens for vertically collecting light from the LED, and
a cable path for passing a cable connected to the LED to the socket, and the socket comprises,
a driving substrate connected to the cable from the LED and solder-connected to the electrode pin,
an electrode hole for passing the electrode pin to the outside,
a guide for removable engagement of the driving substrate, and
a hooking portion capable of being coupled to a socket engagement hole of the body.

2. The LED lamp according to claim 1, wherein the front cover excludes a front ventilation opening and a fixation bolt on a front portion.

3. The LED lamp according to claim 1, wherein the section of the electrode pin coupled to the electrode hole of the socket is circle, rectangle, or hexagon as the same as that of the electrode hole, whereby the electrode hole and the electrode pin are closely engaged with each other.

4. The LED lamp according to claim 1, wherein the body is usable for both 3×LED lamp and 1×LED lamp.

5. The LED lamp according to claim 1, wherein the electrode pin connected to the driving substrate is L-shape or straight.

6. The LED lamp according to claim 1, wherein the body comprises a heat conductive metal.

7. The LED lamp according to claim 1, wherein the body further comprises a heat dissipation groove connected to the side ventilation opening, and extended from upper to lower portion of an outer surface of the body, to efficiently dissipate heat generated from the LED.

8. The LED lamp according to claim 6, wherein the heat dissipation groove formed on the surface of the body is formed clockwise or counterclockwise.

9. The LED lamp according to claim 1, wherein the section of the side ventilation opening is rectangle, circle, or oval.

10. The LED lamp according to claim 1, wherein the socket excludes adhesives in an interior portion.
